(19) United States
(12) Patent Application Publication
(10) Pub. No.: US 2016/0017992 A1
(43) Pub. Date: Jan. 21, 2016

(54) Hydraulic Parallel Path Continuously Variable Transmission

(71) Applicant: Caterpillar Inc., Peoria, IL (US)

(72) Inventor: Brian Lister, Edwards, IL (US)

(73) Assignee: Caterpillar Inc., Peoria, IL (US)

(21) Appl. No.: 14/334,006

(22) Filed: Jul. 17, 2014

(51) Int. Cl. F16H 61/4069; F16H 61/472; F16H 61/47; F16H 47/04

(52) U.S. Cl. CPC F16H 61/4069; F16H 47/04; F16H 61/472; F16H 61/47

(57) ABSTRACT

A hydro-mechanical continuously variable transmission utilizing a variator having a pump hydraulically interconnected with a motor wherein shutoff valves are provided between the pump and the motor and wherein the motor includes an output line having a restricting valve therein such that the pump may be hydraulically decoupled from the motor and the restricting valve on the motor output may be controlled to achieve a desired motor torque.

### TECHNICAL FIELD

The present disclosure relates generally to the field of hydraulic continuously variable transmissions (CVTs), and more particularly, to hydraulic continuously variable transmissions that utilize a hydro-mechanical variator and a planetary gear train to facilitate a power split before it is summated at an output, and even more particularly to such a transmission wherein operating torque is derived from hydraulically decoupling the variator pump and utilizing a restricting valve on the hydraulic motor output to generate desired torque.

### BACKGROUND

For machines that are not directly driven by their respective power sources, a transmission is a critical component of the drive train, affecting both performance and efficiency. Transmissions fulfill many roles, including, for example, gear reduction or amplification to match final drive speed and/or torque to engine speed and/or torque, connection and disconnection between the power source and the final drive, drive train shock absorption, machine energy absorption, i.e., during machine slowing, and so on. While the fulfillment of many of these goals requires a certain amount of complexity within the transmission system, this same complexity can lead to problems in transmission controllability and stability.

Hydraulic transmissions and drives can be used to great benefit in many scenarios, but are fairly complex. Such transmissions include without limitation hystat, hydromechanical, or other transmissions or drives that include a hydraulic pump/motor system also known as a variator. One of the more useful but complex hydraulic transmission systems is the hydromechanical split torque (or parallel path) transmission, which will be discussed by way of example herein. This transmission type provides numerous advantages over typical mechanical transmissions used in earth-working machines, such as tractors, bulldozers, and wheel loaders. For example, a hydromechanical transmission is typically able to provide continuous speed control and more effective and efficient management of engine speed.

One limitation of some prior-art hydromechanical split torque transmission configurations is that they may be designed such that for the machine to be at zero ground speed (i.e. when the vehicle is not moving in forward or reverse) when the engine is engaged and running, a launch clutch must be slipped. Thus, a vehicle employing such a prior-art transmission will always “creep” if a clutch of the transmission is engaged. Such a transmission configuration is not in a desired operating state if the transmission is engaged and the brakes applied strongly enough to bring the machine to a stop. This is because in such conditions, either the engine has stalled (or is near stalling), the variator is at or near exceeding pressure relief limits, or the transmission clutch is slipping.

One way of overcoming this “creep” limitation is to connect the variator output side directly to the output shaft by way of a variator clutch. In such an arrangement the variator would be connected to the input side of the summing transmission as normal, but could be selectively connected directly to the output shaft when the clutch between the summing transmission output and the output shaft is disengaged. The transmission thus modified can then not only achieve zero speed with a clutch engaged but can also provide very low output speeds for a crawling/inching mode, and launch the vehicle from zero output speed into the standard transmission modes by varying the output of the variator. One disadvantage, however, of this solution is that the additional parts required to connect the variator in this way increase the overall cost and complexity of the transmission.

Furthermore there are some limitations with existing designs even in hydraulic parallel path transmissions that do not require a launch clutch. For example, U.S. Pat. No. 7,530,914 to Fabry et al. describes such a parallel path transmission. However, while not having the launch clutch limitations described above, transmissions such as the one described in Fabry et al. may have limitations including total loss or reduction of transmission functionality in the event of a variator pump system fault, and/or operational restrictions during periods of transmission oil warm-up due in part to variator pump system restrictions.

Accordingly, for these reasons and others, it may be desired to have a variator-assisted transmission that mitigates some or all of the aforementioned disadvantages.

### SUMMARY

According to a first aspect of the disclosure there is provided a hydro-mechanical parallel path transmission including a variator having a motor and a pump, a summing transmission connected to an output side of the variator, and a clutch for selectively connecting the summing transmission to an output member, wherein the hydraulic loop between the motor and the pump may be selectively decoupled.

More specifically, according to aspects of the disclosure, in a variator-assisted hydro-mechanical parallel path transmission, the hydraulic loop between the pump and motor of the variator may be shut off thereby removing the pump from the hydraulic loop while simultaneously opening a restricting valve on the output side of the motor. It is a further aspect of the disclosure to provide a control loop such that the restricting valve may be controlled to allow more or less hydraulic flow to the accumulator, as desired, to achieve the desired torque output from the motor.

Even more specifically, a system and method is disclosed wherein a variator in a hydraulic parallel path continuously variable transmission may be decoupled from the hydraulic circuit between the variartor and the motor to provide desired torque from the motor for various applications.

### BRIEF DESCRIPTION OF THE DRAWINGS

FIG. 1 illustrates a sectional view of a hydromechanical transmission in accordance with aspects of the present disclosure;

FIG. 2 illustrates a schematic view of the hydromechanical transmission for use in accordance with aspects of the present disclosure shown in FIG. 1; and

FIG. 3 is a flow diagram illustrating a method for controlling hydraulic fluid flow to a variator system utilized in accordance with aspects of the present disclosure.

### DETAILED DESCRIPTION

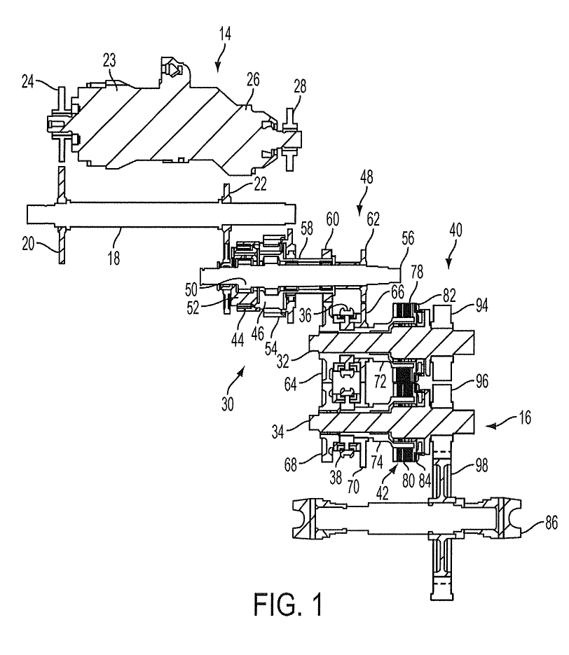

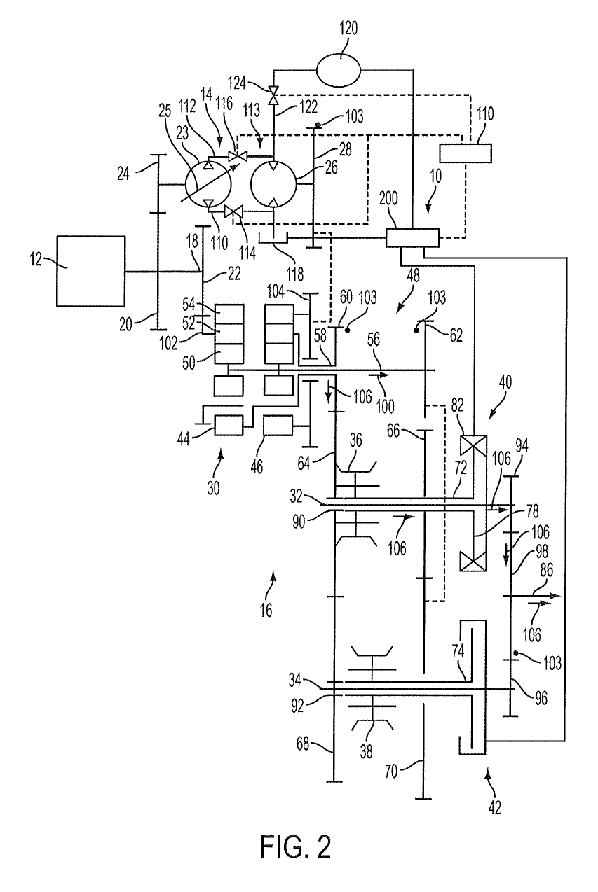

FIG. 1 illustrates a cross-sectional view of an exemplary continuously variable transmission in accordance with aspects of the present disclosure. The continuously variable transmission may be a hydromechanical transmission 10 having a variator, such as a variator (pump and motor) 14, and a mechanical transmission 16. An engine 12 (See FIG. 2) drives the hydromechanical transmission 10 and may be an internal combustion engine, however, it may be any kind of device capable of powering the hydromechanical transmission 10 as described herein. The engine 12 outputs to the hydromechanical transmission 10, through an input member 18.

The input member 18 provides split power to the variator 14 and the mechanical transmission 16 through first and second fixed input gears 20 and 22. The term “fixed” may be understood as being integral with, permanently attached, interconnected through a splined connection, or fused by welding, for example, or by any other means known to those having ordinary skill in the art.

The variator 14 includes a variable displacement variator pump 23 having a control element or swash plate 25 of a known type, and is drivingly connected to the engine 12, through a variator input gear 24, and a motor 26, which outputs through a variator output gear 28 to the mechanical transmission 16. The motor 26 may be variable displacement or fixed displacement. The motor 26 and variator pump 23 may be hydraulically linked by lines 111, 112 forming a hydraulic loop 113 therebetween. Each line 111, 112 may include a corresponding shutoff valve 114, 116, each of which may be controlled via controller 110 to selectively decouple portions of the loop 113 between the motor 26 and variator pump 23. The loop 113 may include a hydraulic reservoir 118 and be hydraulically connected to an accumulator 120 on the motor 26 side of the loop 113 through an output line 122 having a restricting valve 124 therein. As is known in the art, the accumulator 120 acts to accumulate hydraulic fluid for recirculation to the hydraulic reservoir 118, possibly through a filter (not shown) and/or manifold 200.

The mechanical transmission 16 includes a planetary arrangement 30, first and second output members 32 and 34, first and second synchronizing assemblies, or synchronizers 36 and 38, and first and second disc clutch assemblies 40 and 42.

The planetary arrangement 30 includes first and second axially aligned planetary gear sets 44 and 46, and a planetary output shaft 48. Each planetary gear set 44 and 46 includes a sun gear 50, a carrier 52, and a ring gear 54, as is customary. The planetary output shaft 48 includes an internal shaft 56 and a sleeve 58, such as a hollow member or hub, which is supported by the internal shaft 56. Both the internal shaft 56 and the sleeve 58 exist in axial alignment with each other. The internal shaft 56 connects to the sun gears 50 of the first and second planetary gear sets 44 and 46. The sleeve 58 outputs from the carrier 52 of the second planetary gear set 46 through a first planetary output gear 60. The internal shaft 56 outputs from the sun gears 50 of the first and second planetary gear sets 44 and 46 through a second planetary output gear 62.

The first and second output members 32 and 34 are positioned parallel to the input member 18 and the planetary arrangement 30. The first output member 32 includes a first low-speed reduction gear 64 and a first high-speed reduction gear 66. The second output member 34 includes a second low-speed reduction gear 68 and a second high-speed reduction gear 70.

Each synchronizer 36 and 38 is fixed to a first and second hub, sleeve, or rotating members 72 and 74, respectively, which rotates about the corresponding first or second output member 32 and 34. The synchronizers 36 and 38 are three-position synchronizers adapted to move from a neutral position to either of two positions, dependent on a preferred speed and direction.

Each hub 72 and 74 includes at least one rotatable disc 78 and 80 fixed to an end of the hub 72 and 74, which may be “clutched” or selectively retained by an engaging means, or friction-disc clutches 82 and 84, which generally overlays the rotatable discs 78 and 80, as is customary. Together, the rotatable discs 78 and 80 and friction-disc clutches 82 and 84 embody the first and second clutch assemblies 40 and 42. In one embodiment, the clutch assemblies 40 and 42 are known hydraulically-engaged and spring-disengaged rotating frictional clutch assemblies which may be selectively engaged to provide power to the first or second output members 32 and 34 and to a final output member 86.

The low-speed and high-speed reduction gears 64, 66, 68, and 70 freely rotate about the first and second output members 32 and 34 while disengaged. Roller bearings 90 and 92 on the first and second output members 32 and 34 support the low-speed and high-speed reduction gears 64, 66, 68, and 70. When either of the first or second synchronizers 36 and 38 is engaged with either of the low-speed or high-speed reduction gears 64, 66, 68, and 70, the first or second hub 72 and 74 rotates at the same revolutions per unit of time as the engaged low-speed or high-speed reduction gear 64, 66, 68, and 70.

First and second output shaft gears 94 and 96 fixed to the first and second output members 32 and 34 intermesh a final drive gear 98 of the final output member 86. The input member 18, planetary output shaft 48, first and second output members 32 and 34, and final output member 86 are supported within a transmission housing (not shown) and rotate about bearings, or the like, (not shown) held within the housing.

In operation, the input member 18 delivers split input power to the variator 14 and the planetary arrangement 30. Specifically, the first and second fixed input gears 20 and 22 simultaneously rotate upon rotation of the input member 18 and transfer power through the variator input gear 24 and a first planetary input member 102. The variator pump 23 of the variator 14 uses the split input power to fluidly drive a motor 26 to convert the input power from the engine 12 to hydrostatic output power over a continuously variable speed ratio. The variator 14 outputs through the hydrostatic output gear 28 to the planetary arrangement 30. Specifically, the variator 14 outputs through the hydrostatic output gear 28 to a second planetary input member 104.

The planetary arrangement 30 combines the hydrostatic output power from the second planetary input member 104 with the split input mechanical power to provide hydromechanical output power for application to a load, such as one or more driving wheels of a vehicle, or tracks of an earth-working machine. The speed and torque in each of the power ranges initially set by gear ratios of the planetary arrangement 30 can be infinitely varied by varying the stroke of the variator 14.

The combined hydromechanical output power, indicated as arrows 100 and 106, outputs through the internal shaft 56 connected to the sun gears 50 of the first and second planetary gear sets 44 and 46, and through the sleeve 58, connected to the planet carrier 52 of the second planetary gear set 46. The second planetary output gear 62 intermeshes the second high-speed reduction gear 70, which drives the first high-speed reduction gear 66. Accordingly, as the second planetary output gear 62 rotates, the high-speed reduction gears 66, 70 also rotate. Likewise, the first planetary output gear 60 intermeshes the first low-speed reduction gear 64, which drives the second low-speed reduction gear 68. Accordingly, as the first planetary output gear 60 rotates, the low-speed reduction gears 64, 68 also rotate.

Referring specifically to FIG. 2, in order to output a low-speed in the forward direction, the first synchronizing assembly 36 operates to engage the first low-speed reduction gear 64 to the first hub 72. After the first low-speed reduction gear 64 and the first hub 72 engage, the first friction-disc clutch 82 of the first clutch assembly 40 operates to “clutch” the rotatable disc 78. When the first friction-disc clutch 82 fully clutches the rotatable disc 78, the first output shaft gear 94 drives the final drive gear 98, which outputs through the final output member 86 to the wheels or tracks. Arrows 106 indicate power flow. The transmission 10 operates normally within the low-forward range as a continuously variable hydromechanical transmission. As long as the second synchronizing assembly 38 remains disengaged, the relative speed, and therefore the viscous drag loss of the second clutch assembly 42, is substantially zero.

The clutches in the illustrated embodiment are hydraulically actuated, and the transmission 10 further comprises at least one hydraulic fluid manifold 200 which includes at least one control valve (not shown). The manifold 200 controls flow of hydraulic fluid from the hydraulic reservoir 118 to the low and high speed clutches 40,42. The transmission 10 also includes a plurality of sensors 103 which monitor the rotational speed of the output elements of the variator 14 (that is, the ring gear 54 and the internal shaft 56) on an input side of the low and high speed clutches 40, 42 and the output shaft 86 or second intermediate shaft 158 on an output side of the clutches 40, 42. A controller 110 receives data from the sensors 103 and from that data can establish the degree of clutch slip, if any in the clutches 40, 42.

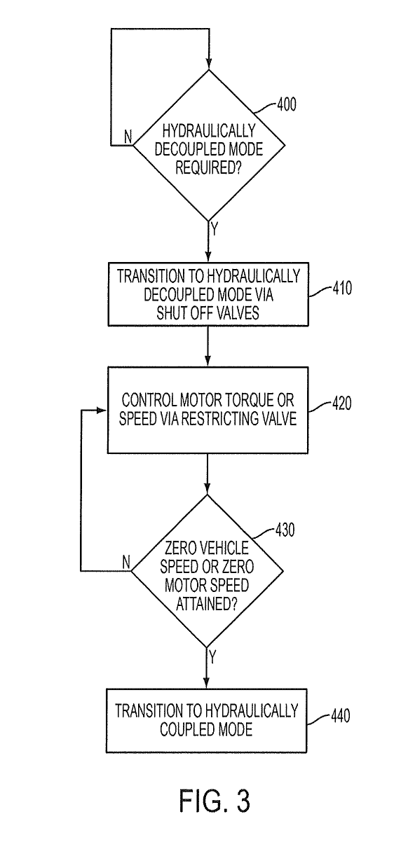

When operating conditions are such that machine speed is at or very near zero (i.e. final output member 86 is at zero or near zero rotational speed), variator pump 23 must be operating at maximum or near maximum displacement and motor 26 must be operating at maximum or near maximum speed. Accordingly, as shown in FIG. 3, when operating conditions are as such, and/or other situations wherein it is desirable to decouple the variator pump 23 from the motor 26 (i.e. in the event of a variator pump 23 system fault, and/or operational restrictions during periods of transmission 10 oil warm-up due in part to variator pump 23 system restrictions), hydraulically decoupled mode 400 is actuated by controller 110. Upon actuation of hydraulically decoupled mode 400, shutoff valves 114 and 116 are closed 410, hydraulically decoupling variator pump 23 in the hydraulic loop 113. Next, restricting valve 124, which is normally in a completely closed configuration during normal operation, is controlled by controller 110 to control motor 26 torque or speed 420 as conditions require until zero vehicle speed or zero motor 26 speed is attained 430. Next, shutoff valves 114 and 116 are opened and restricting valve 124 is closed returning the system to hydraulically coupled mode 440, i.e. normal operating condition.

### INDUSTRIAL APPLICABILITY

The present disclosure advantageously provides a system and method for hydraulically controlling a variator 14 in a hydromechanical transmission 10 that allows the hydraulic loop 113 between the motor 26 and the variator pump 23 to be selectively decoupled and a restricting valve 124 on the output of the motor 26 to be controlled in order to achieve a desired torque or speed from the motor 26. More specifically, the present disclosure provides shutoff valves 114, 116 that may be controlled to shutoff hydraulic flow to the variator pump 23 when vehicle conditions require and a secondary output line 122 from the motor 26 to an accumulator 120 having a normally-closed restricting valve 124 therein.

According thereto, the present disclosure provides a system and method for controlling a variator in a parallel path hydromechanical transmission that provides an efficient and effective way for providing desired motor 26 torque or speed when a zero or near zero vehicle speed is required without operating the variator pump 23 at maximum or near maximum output levels. Furthermore, the present disclosure provides such utility without requiring a method wherein the operator must slip the clutch or engage the brakes in order to achieve zero vehicle speed. Accordingly, the present disclosure provides increased safety and less risk for operator error, as well as provides a vehicle transmission that is efficient and less prone to failure. Such a method and system is therefore useful in any number of vehicles and applications wherein hydro-mechanical transmissions have previously been employed including, but not limited to, track-type earth moving vehicles, tractors, bulldozers, mining trucks, pavers, cold planers, draglines, compactors, excavators, graders, shovels, etc.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

We claim:

1. A hydro-mechanical continuously variable transmission comprising:
an input member connected to a vehicle engine;
a variator connected to the input member, the variator comprising a hydraulically interconnected pump and motor;
shutoff valves between the pump and the motor and an output line from the motor having a restricting valve therein, the shutoff valves and the restricting valve being controlled by a controller;
wherein, in response to a predetermined vehicle condition, the controller controls said shutoff valves to hydraulically decouple the pump from the motor and controls the restricting valve to achieve a desired torque or speed from the motor.

2. The hydro-mechanical continuously variable transmission of claim 1 further comprising a hydraulic manifold controlled by the controller hydraulically connected to the output line.

3. The hydro-mechanical continuously variable transmission of claim 2 further comprising an accumulator located between the manifold and the restricting valve.

4. The hydro-mechanical continuously variable transmission of claim 3 wherein the manifold is hydraulically connected to the motor.

5. The hydro-mechanical continuously variable transmission of claim 4 further comprising a hydraulic reservoir hydraulically connected between the manifold and the motor.

6. The hydro-mechanical continuously variable transmission of claim 1 wherein the predetermined vehicle condition is a zero or near zero vehicle speed being requested by an operator.

7. The hydro-mechanical continuously variable transmission of claim 1 wherein the predetermined vehicle condition is a pump system fault condition.

8. The hydro-mechanical continuously variable transmission of claim 1 wherein the predetermined vehicle condition is a transmission oil warm-up condition.

9. The hydro-mechanical continuously variable transmission of claim 1 wherein following achieving a desired torque or speed from the motor, the controller controls the shutoff valves to recouple the pump and the motor and closes the restricting valve.

10. A method for controlling a hydro-mechanical continuously variable transmission comprising the steps of:
selecting an input member connected to a vehicle engine;
selecting a variator connected to the input member, the variator comprising a hydraulically interconnected pump and motor and having shutoff valves between the pump and the motor and an output line from the motor having a restricting valve therein, the shutoff valves and the restricting valve being controlled by a controller;
utilizing the controller to control said shutoff valves to hydraulically decouple the pump from the motor in response to a predetermined vehicle condition;
utilizing the controller to control the restricting valve to achieve a desired torque or speed from the motor;
utilizing the controller to close the restricting valve and open the shutoff valves in response to a zero vehicle or zero motor speed being attained.

11. The method for controlling a hydro-mechanical continuously variable transmission of claim 10 further comprising the step of selecting a hydraulic manifold controlled by the controller hydraulically connected to the output line.

12. The method for controlling a hydro-mechanical continuously variable transmission of claim 11 further comprising the step of selecting an accumulator located between the manifold and the restricting valve.

13. The method for controlling a hydro-mechanical continuously variable transmission of claim 12 wherein the manifold is hydraulically connected to the motor.

14. The method for controlling a hydro-mechanical continuously variable transmission of claim 13 further comprising the step of selecting a hydraulic reservoir hydraulically connected between the manifold and the motor.

15. The method for controlling a hydro-mechanical continuously variable transmission of claim 10 wherein the predetermined vehicle condition is a zero or near zero vehicle speed being requested by an operator.

16. The method for controlling a hydro-mechanical continuously variable transmission of claim 10 wherein the predetermined vehicle condition is a pump system fault condition.

17. The method for controlling a hydro-mechanical continuously variable transmission of claim 10 wherein the predetermined vehicle condition is a transmission oil warm-up condition.

18. The method for controlling a hydro-mechanical continuously variable transmission of claim 10 wherein following achieving a desired torque or speed from the motor, the controller controls the shutoff valves to recouple the pump and the motor and closes the restricting valve.

19. The method for controlling a hydro-mechanical continuously variable transmission of claim 10 wherein the desired speed from the motor is at or near zero.

20. A hydro-mechanical continuously variable transmission comprising:
an input member connected to a vehicle engine;
a variator connected to the input member, the variator comprising a hydraulically interconnected pump and motor;
shutoff valves between the pump and the motor and an output line from the motor having a restricting valve therein further hydraulically connected to a manifold, the shutoff valves, restricting valve and manifold being controlled by a controller;
wherein, in response to a predetermined vehicle condition, the controller controls said shutoff valves to hydraulically decouple the pump from the motor and controls the restricting valve to achieve a desired torque or speed from the motor, and then following achieving a desired torque or speed from the motor, the controller controls the shutoff valves to recouple the pump and the motor and closes the restricting valve.
